(19) United States
(12) Patent Application Publication
(10) Pub. No.: US 2015/0235756 A1
(43) Pub. Date: Aug. 20, 2015

(54) PSEUDO EDGE-WOUND WINDING USING SINGLE PATTERN TURN

(71) Applicant: HONEYWELL INTERNATIONAL INC., Morristown, NJ (US)

(72) Inventors: Keming Chen, Torrance, CA (US); Evgeni Ganev, Torrance, CA (US); William Warr, Glendale, CA (US)

(73) Assignee: HONEYWELL INTERNATIONAL INC., MORRISTOWN, NJ (US)

(21) Appl. No.: 14/181,806

(22) Filed: Feb. 17, 2014

(51) Int. Cl. H01F 27/28; H01F 41/02

(52) U.S. Cl. CPC H01F 27/2852; H01F 41/0233

(57) ABSTRACT

A winding system may include a plurality of metal plates including the same shape and size, such that the plates are stacked, and each of the plurality of metal plates is reversely positioned with respect to a gap pattern in an adjacent one of the plurality of metal plates.

### BACKGROUND OF THE INVENTION

Conventional edge-wound technology may use a flat-wire wound onto a bobbin. The wide edge may be placed vertically on a bobbin in order to obtain single layer design with a maximum number of turns. If only one layer is wound, this may improve the heat transfer to the environment or to a heat sink. A larger ratio between a wide edge and a narrow edge may result in increased power density of the device. However, there may be problems in fabricating a wire with such a high ratio of these dimensions. For example, the higher the ratio, the more difficult it may be to wind the wire around a rectangular bobbin.

In addition, windings may be subject to a minimal turn radius and thus, large voids between the wire and the core may occur that may result in power losses and difficulties in cooling the device.

As can be seen, there is a need for a new method of creating windings around a bobbin or transformer core.

### SUMMARY

In one aspect of the invention, a winding system, comprises a plurality of metal plates including the same shape and size, wherein the plates are stacked and connected together, and wherein each of the plurality of metal plates is reversely positioned with respect to a gap pattern in an adjacent one of the plurality of metal plates.

In another aspect of the invention, a winding system, comprises a first stack of plates stacked, wherein each of the plates in the first stack of plates is reversely positioned with respect to a gap pattern in an adjacent plate in the first stack of plates; and a second stack of plates is positioned adjacent to the first stack of plates, wherein each of the plates in the second stack of plates is reversely positioned with respect to a gap pattern in an adjacent plate in the second stack of plates.

In another aspect of the invention, a method for stacking plates for a winding comprises positioning a first plate in a first orientation with respect to a gap pattern on the first plate; reversing a second plate with respect to the gap pattern on the first plate; and brazing the first plate to the second plate.

These and other features, aspects and advantages of the present invention will become better understood with reference to the following drawings, description and claims.

### BRIEF DESCRIPTION OF THE DRAWINGS

FIG. 1 illustrates a system of stacks of single pattern plates placed around a transformer core;

FIG. 2 shows plates with three different patterns for use with the system of FIG. 1;

FIG. 3 illustrates a perspective view of a stack of plates for use with the system of FIG. 1;

FIG. 4 is a flow chart of a method of stacking single pattern plates as shown in FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

Broadly, an embodiment of the present invention generally provides a winding for autotransformers, transformers, and inductors.

More specifically, the present invention may provide a pseudo-edge-wound winding for autotransformers, transformers, and inductors using a single pattern metal sheet.

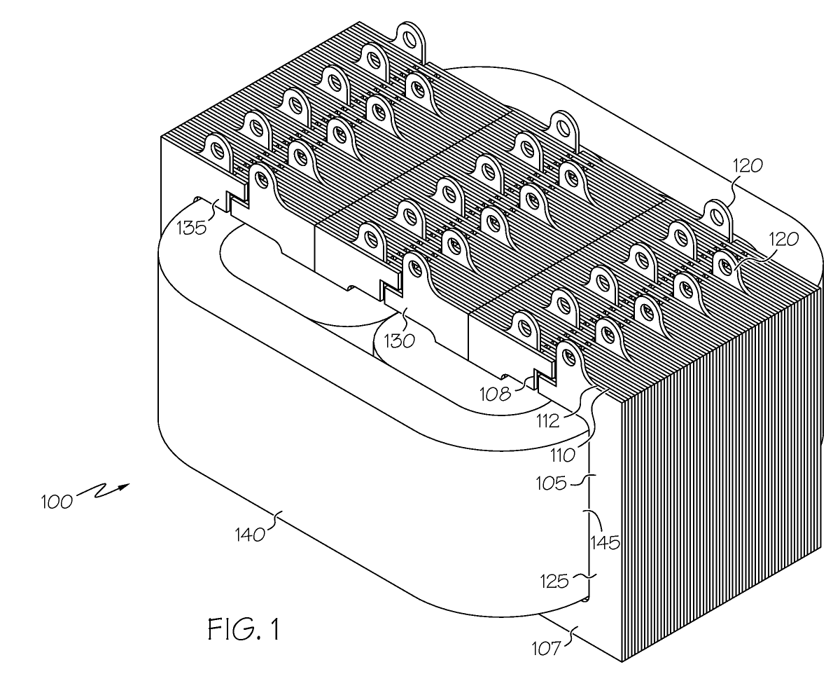

FIG. 1 illustrates a system 100 of a first stack 125 of plates, a second stack 130 of plates, and a third stack 135 of plates such that the plates are metallic plates of the same shape and size (referred to in general as stack 125, stack 130, and stack 135). A plate 105 may include a rim 107 encircling a hole 145. The plate may include a gap 108 that may be in a variety of patterns, such as a zig zag pattern. The plate 105 may include a lug 120. The plate 105 may be made of metallic material. The plate 105 may be electrically conductive.

The stacks (125, 130, 135) may include a front plate 105 and a second plate 110 that are reversed with respect to each other with respect to a gap 108 in the plates (105, 110). The lugs 120 may extrude from one end 112 of the plate 105, and may allow for attachment to an external wire (not shown). The gap 108 in the plates may allow the plates to form one continuous wire. Each of the plates in the stacks (125, 130, 135) of plates may be brazed together near the gap 108 so that the plates in the stacks (125, 130, 135) form a continuous wire that may conduct electricity. By alternating plates with respect to each other, the gap allows the plates to form a continuous loop from the front plate 105 plate to the second plate, by connecting the front plate to the second plate by brazing only at one point near the gap 108.

One of the plates in the stacks (125, 130, 135) may vary in size, shape, width, and thickness, and may be made of various material that conducts electricity. In an exemplary embodiment, the stacks (125, 130, 135) of plates may be made of aluminum, copper, or other conductors of electricity. In an embodiment, each of the plates in the stacks (125, 130, 135) of plates may be of a same shape and size. A transformer core 140 may be inserted through a hole 145 in the stacks (125, 130, 135) of plates.

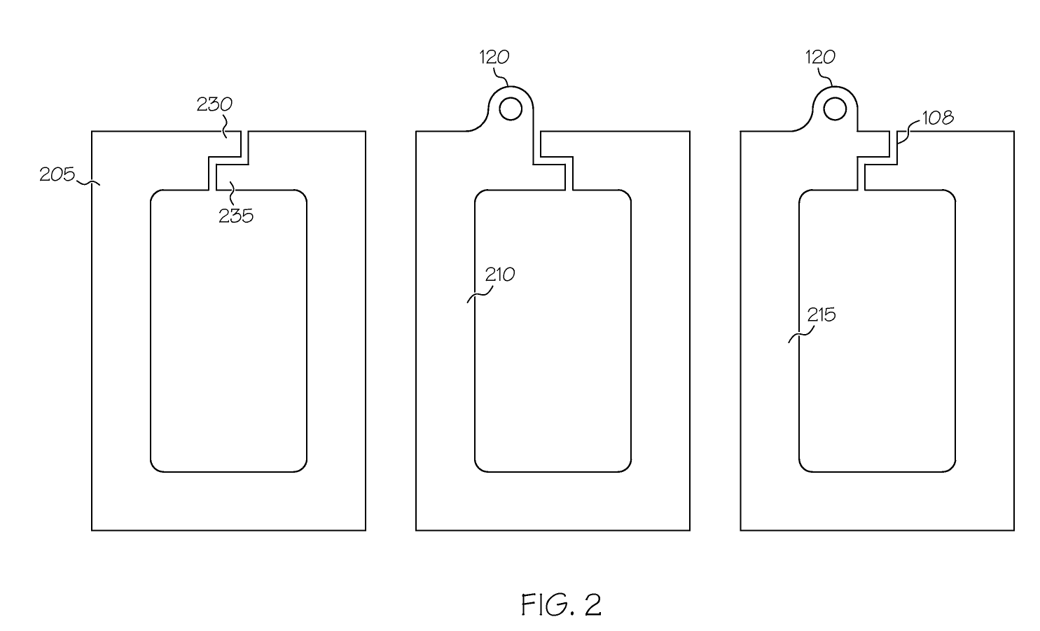

FIG. 2 illustrates metallic plates using single pattern turns. Shown are a first plate 205, a second plate 210, and a third plate 215, each with a same basic pattern but different pattern for a lug 120. The second plate 210 and the third plate 215 are shown with a lug 120 for external electrical interface. The first plate, 205, second plate 210, and third plate 215 may be stacked in stacks of the same pattern. Plates 205, 210, 215 may be added in a same pattern in front of and behind a middle one of the first plate 205, second plate 210, or third plate 215. The gap 108 is shown in a zig-zag pattern. Other patterns for plates may be used. In an exemplary embodiment, a first brazing area 230 or a second brazing area 235 in the opposite side may be brazed on stacks of the plates (205, 210, or 215) in order to form a single continuous electrically conducting wire.

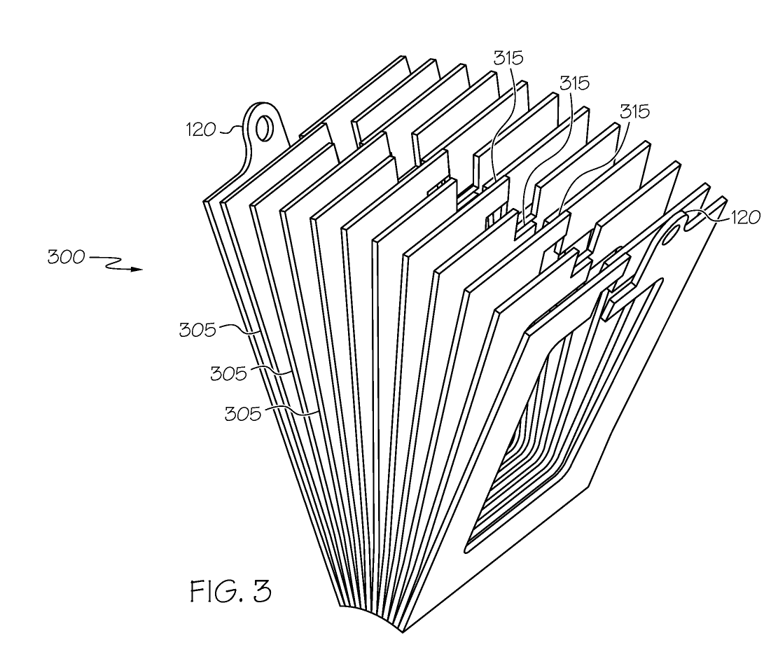

FIG. 3 illustrates a stack 300 of plates 305 with lugs 120 attached to two of the plates 305. Also shown are connectors 315 configured to secure the plates 305 to each other. The connectors 315 may be used to create a single continuous wire from the stack 300 of plates 305.

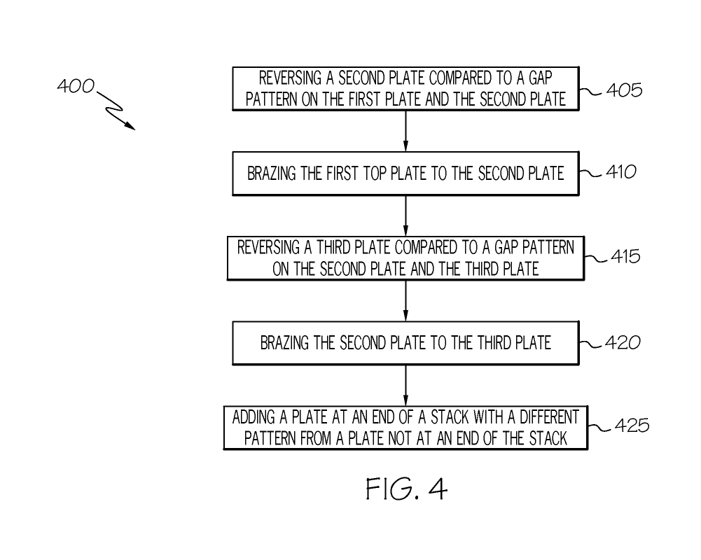

FIG. 4 illustrates a method 400 of providing an edge-wound winding according to an exemplary embodiment of the invention. The method may form a winding as follows. A step 405 may include reversing a second plate compared to a gap pattern on the first plate and the second plate. A step 410 may include brazing the first top plate to the second plate. A step 415 may include reversing a third plate compared to a gap pattern on the second plate and the third plate. A step 420 may include brazing the second plate to the third plate. Creating a stack of plates may be lower in cost to creating a one piece plate equal in size to the stack of plates. In addition, a cooling performance may be higher than the cooling performance of a one piece plate equal in size to the stack of plates. In an embodiment, brazing for all plates may be performed simultaneously. A step 425 may include adding a plate at an end of a stack with a different pattern such as a different lug position from a plate not at an end of the stack.

It should be understood, of course, that the foregoing relates to exemplary embodiments of the invention and that modifications may be made without departing from the spirit and scope of the invention as set forth in the following claims.

We claim:

1. A winding system, comprising:
a plurality of metal plates including the same shape and size,
wherein the plurality of metal plates are stacked and connected together, and
wherein each of the plurality of metal plates is reversely positioned with respect to a gap pattern in an adjacent one of the plurality of metal plates.

2. The winding system of claim 1, wherein the plurality of metal plates are configured to encircle a transformer core.

3. The winding system of claim 1, wherein the plurality of plates are made of an electrically conductive material.

4. The winding system of claim 2, wherein the core is made of a magnetic material.

5. The winding system of claim 1, wherein one of the plurality of metal plates includes an interface lug on one end of each of the plurality of metal plates.

6. The winding system of claim 1, wherein the gap pattern forms a zig-zag pattern on one end of one of the plurality of metal plates.

7. The winding system of claim 1, wherein each plate in the plurality of metal plates are brazed together.

8. A winding system, comprising:
a first stack of plates stacked,
wherein each of the plates in the first stack of plates is reversely positioned with respect to a gap pattern in an adjacent plate in the first stack of plates; and
a second stack of plates is positioned adjacent to the first stack of plates,
wherein each of the plates in the second stack of plates is reversely positioned with respect to a gap pattern in an adjacent plate in the second stack of plates.

9. The winding system of claim 8, wherein the first stack of plates and the second stack of plates are made of an electrically conductive material.

10. The winding system of claim 8, wherein one of the plates in the first stack of plates and the second stack of plates includes an interface lug on one end of the respective plate.

11. The winding system of claim 8, wherein the gap pattern forms a zig-zag pattern on one end of one of the first stack of plates or second stack of plates.

12. The winding system of claim 8,
wherein each plate in the first stack of plates are brazed together and
wherein each plate in the second stack of plates are brazed together.

13. A method for stacking plates for a winding, comprising:
positioning a first plate in a first orientation with respect to a gap pattern on the first plate;
reversing a second plate with respect to the gap pattern on the first plate; and
brazing the first plate to the second plate.

14. The method of claim 13, including adding additional plates adjacent to the first plate, wherein each of the added additional plates is reversely positioned with respect to a gap pattern on an adjacent one of the added additional plates.

15. The method of claim 13, including adding additional plates adjacent to the second plate, wherein each of the added additional plates is reversely positioned with respect to a gap pattern on an adjacent one of the added additional plates.

16. The method of claim 14, wherein each of the additional plates is brazed to another one of the added additional plates, and one of the added additional plates is brazed to the first plate.

17. The method of claim 15, wherein each of the additional plates is brazed to another one of the added additional plates, and one of the added additional plates is brazed to the second plate.

18. The method of claim 13, wherein the first plate, and the second plate are configured to encircle a core.

19. The method of claim 14, wherein the first plate, the second plate, and the additional plates on top of the first top plate, are configured with a single pattern.

20. The method of claim 14, wherein the first plate, the second plate, and the additional plates on top of the first plate are made of an electrically conductive material.
